(19) United States
(12) Patent Application Publication
(10) Pub. No.: US 2023/0011688 A1
(43) Pub. Date: Jan. 12, 2023

(54) ELECTRIC WIRE COVER

(71) Applicant: Yazaki Corporation, Tokyo (JP)

(72) Inventors: Youngho JANG, Aichi (JP); Ryohei TOYODA, Aichi (JP); Jin WATANABE, Shizuoka (JP)

(73) Assignee: Yazaki Corporation, Tokyo (JP)

(21) Appl. No.: 17/859,279

(22) Filed: Jul. 7, 2022

(30) Foreign Application Priority Data
Jul. 9, 2021 (JP) 2021-114296

(51) Int. Cl. H01R 13/58

(52) U.S. Cl. CPC H01R 13/5804; H01B 7/184

(57) ABSTRACT

An electric wire cover includes halved covers in a pair mounted to a connector having at least one electric wire drawn rearward, and an electric wire protector. The respective halved covers have electric wire insertion portions through which the drawn electric wire is inserted. The electric wire protector is elastically recoilable in an insertion direction of the electric wire and retained in the electric wire insertion portions of the halved covers. The respective halved covers include regulators in the electric wire insertion portions. The regulators are configured to come in partial contact with an opening edge of the electric wire protector at which the electric wire is exposed, and regulate a position of the electric wire protector.

### CROSS REFERENCE TO RELATED APPLICATION

The present application is based on, and claims priority from the prior Japanese Patent Application No. 2021-114296, filed on Jul. 9, 2021, the entire contents of which are incorporated herein by reference.

### TECHNICAL FIELD

The disclosure relates to an electric wire cover mounted to a connector.

### BACKGROUND

JP 2004-220856 A proposes an electric wire cover mounted to a connector provided at the ends of electric wires. This electric wire cover consists of halved covers in a pair which form a tubular shape by being coupled to each other. On the inner periphery of both the halved covers at their edges through which the electric wires are guided out, there are provided locking portions which allow a corrugated tube to be mounted in the state where the corrugated tube is prevented from falling off. In the vicinity of the locking portions of both the halved covers, there are provided electric wire guides which regulate the diameter of the pathway of the electric wires guided out from the corrugated tube so as to be smaller than the diameter of the inner periphery of the corrugated tube at the end edge of the corrugated tube.

### SUMMARY

In the electric wire cover above, when coupling the halved covers in a pair to each other, the electric wires drawn from the connector are bitten between the electric wire guides of both the halved covers.

The disclosure is directed to an electric wire cover capable of easily and surely preventing an electric wire(s) from being bitten between halved covers in a pair when coupling the halved covers to each other.

An electric wire cover in accordance with some embodiments includes halved covers in a pair mounted to a connector having at least one electric wire drawn rearward, and an electric wire protector. The respective halved covers have electric wire insertion portions through which the drawn electric wire is inserted. The electric wire protector is elastically recoilable in an insertion direction of the electric wire and retained in the electric wire insertion portions of the halved covers. The respective halved covers include regulators in the electric wire insertion portions. The regulators are configured to come in partial contact with an opening edge of the electric wire protector at which the electric wire is exposed, and regulate a position of the electric wire protector.

According to the aforementioned configuration, it is possible to easily and surely prevent an electric wire(s) from being bitten between halved covers in a pair when coupling the halved covers to each other.

### BRIEF DESCRIPTION OF THE DRAWINGS

FIG. 1 is a plan view of an example of an electric wire cover mounted to a connector according to an embodiment.

FIG. 2 is a side view of the electric wire cover mounted to the connector according to the embodiment.

FIG. 3 is a plan view of a lower halved cover of the electric wire cover mounted to the connector according to the embodiment.

FIG. 4 is a perspective cross-sectional view of the main part of the electric wire cover according to the embodiment.

FIG. 5A is a cross-sectional view taken along the line V-V of FIG. 3, according to the embodiment.

FIG. 5B is a cross-sectional view taken along the line V-V of FIG. 3, according to a comparative example.

### DETAILED DESCRIPTION

Various embodiments will be described hereinafter with reference to the accompanying drawings.

A detailed description will be hereinbelow provided for an electric wire cover 10 according to an embodiment by referring to the drawings.

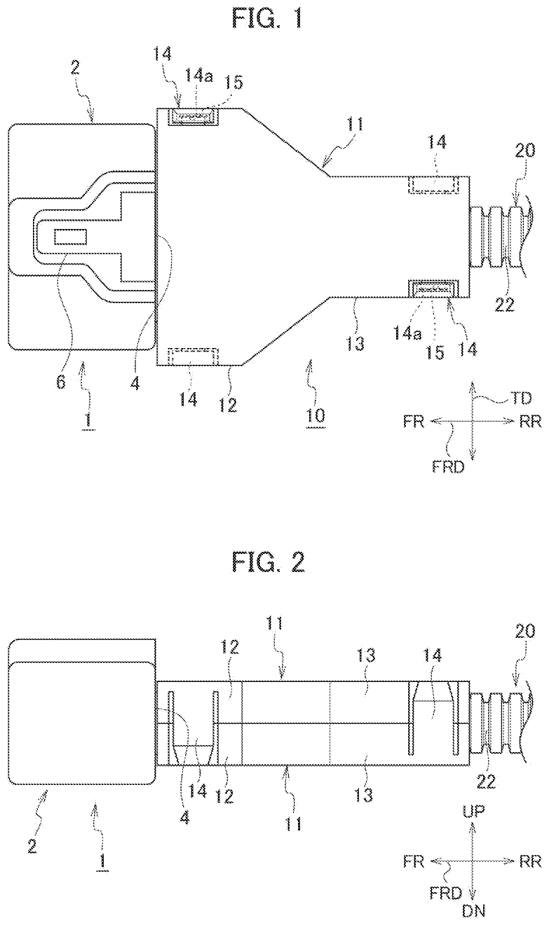

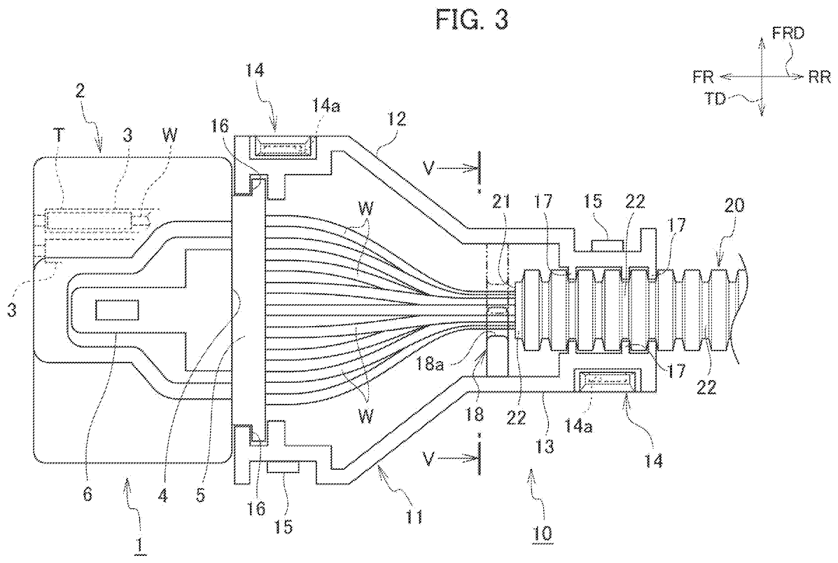

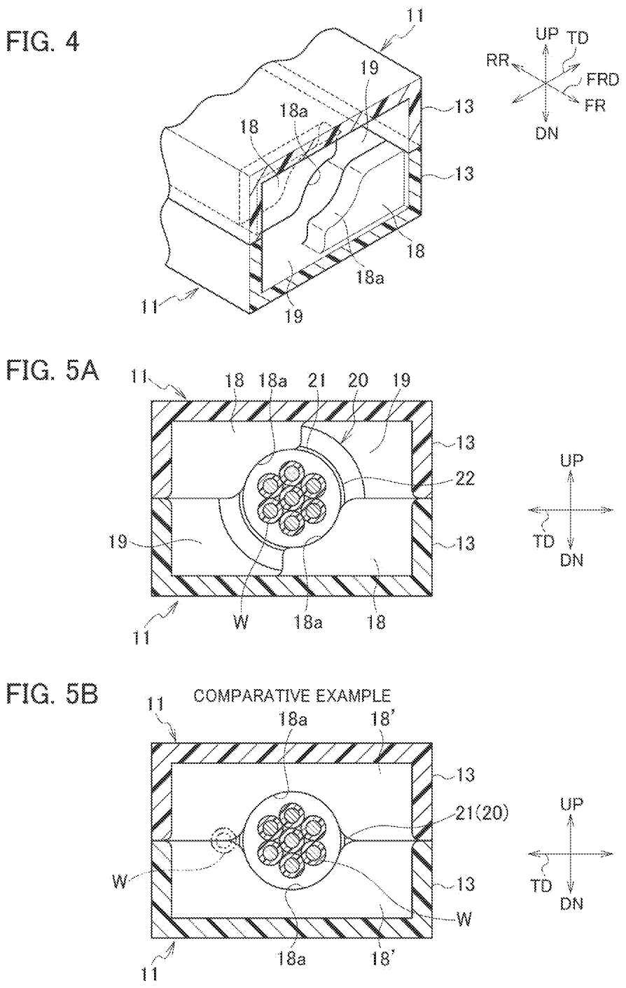

FIG. 1 is a plan view of an example of the electric wire cover 10 mounted to a connector 1 according to an embodiment. FIG. 2 is a side view of the electric wire cover 10 mounted to the connector 1. FIG. 3 is a plan view of a lower halved cover 11 of the electric wire cover 10 mounted to the connector 1. FIG. 4 is a perspective cross-sectional view of the main part of the electric wire cover 10. FIG. 5A is a cross-sectional view taken along the line V-V of FIG. 3, according to the embodiment. FIG. 5B is a cross-sectional view taken along the line V-V of FIG. 3, according to a comparative example. In FIGS. 1 to 5B, the directions of transverse, up, down, front, rear, and front-rear are denoted by TD, UP, DN, FR, RR, and FRD, respectively.

As illustrated in FIGS. 1 to 3, the electric wire cover 10 includes halved covers 11 in a pair made from synthetic resin and a corrugated tube (electric wire protector) 20. The halved covers 11 are mounted to the connector 1 having a plurality of electric wires W drawn rearward. The corrugated tube 20 is retained in the halved covers 11. The halved covers 11 are halved parts having the same shape (the same parts) and coupled to each other such that the lower halved cover 11 and the upper halved cover 11 are placed on one another to be closed.

As illustrated in FIGS. 1 to 3, the connector 1 includes a housing 2 made from synthetic resin and female terminals (terminals) T retained in the housing in the state where the female terminals T are connected to the ends of the electric wires W. The housing 2 includes terminal chambers 3 in which the female terminals T are accommodated. An electric wire drawing portion 5 protrudes from a rear portion 4 of the housing 2 to form a T-shape in a plan view. The electric wire drawing portion 5 draws rearward the electric wires W connected to the female terminals T in the terminal chambers 3. The electric wire cover 10 is mounted to the rear portion 4 of the housing 2 by fitting the electric wire drawing portion 5 into locking recesses 16 provided in broadened width portions 12 of the electric wire cover 10 described later. On the upper portion of the housing 2, there is provided a locking arm 6 which engages with a non-illustrated mating connector to keep the connector 1 mated with the mating connector.

As illustrated in FIGS. 1 and 2, the respective halved covers 11 include the broadened width portions 12 having a box-shape and broadening in both directions of the transverse direction toward the front direction, and electric wire insertion portions 13 having a rectangle tubular shape and extending rearward continuously from the broadened width portions 12, in the state where the halved covers 11 are coupled to each other. The electric wires W drawn rearward from the electric wire drawing portion 5 of the housing 2 are inserted in the broadened width portions 12 having a box-shape and the electric wire insertion portions 13 having a rectangle tubular shape.

As illustrated in FIGS. 1 to 3, engagement pieces 14 and engagement protrusions 15 are provided in an alternating manner protruding from both outer side surfaces of the broadened width portions 12 having a box-shape and both outer side surfaces of the electric wire insertion portions 13 having a rectangle tubular shape. The engagement pieces 14 are elastically displaceable and include engagement recesses 14a. The engagement protrusions 15 are fittable into the engagement recesses 14a of the engagement pieces 14. That is, the engagement pieces 14 and the engagement protrusions 15 arranged in an alternating manner on both outer side surfaces form a locking structure. As illustrated in FIGS. 1 and 2, when the halved covers 11 are coupled to each other, the coupled state is kept by the engagement protrusion 15 of one of the halved covers 11 being fitted and locked in the engagement recess 14a of the engagement piece 14 of the other of the halved covers 11. As illustrated in FIG. 3, the locking recesses 16 which the electric wire drawing portion of the housing 2 is fitted into and engaged with are provided on both inner side surfaces of the broadened width portions 12 having a box-shape. This engagement of the locking recesses 16 allows the halved covers 11 to be mounted to the electric wire drawing portion 5 of the connector 1 having the electric wires W drawn rearward.

As illustrated in FIG. 3, a plurality of retaining protrusions (three retaining protrusions in the embodiment) 17 which lock the corrugated tube 20 with the bundled electric wires W (i.e. a wire harness) inserted therein in the insertion direction (front-rear direction) of the electric wires W are provided on and annularly protrude at the center and the opening side of both inner side surfaces of the electric wire insertion portions 13 having a rectangle tubular shape. As illustrated in FIGS. 4 and 5A, a pair of stoppers (regulators) 18 each having a quarter piece shape are provided on and diagonally (alternately) protrude at the portions of both inner side surfaces of the electric wire insertion portions 13 of the halved covers 11 near the broadened width portions 12. At the facing corners of the pair of stoppers 18 which are alternately positioned, notches 18a formed by cutting out the corners to an arc shape are provided. The inner diameters of the notches 18a having an arc shape are smaller than the outer diameter of a front opening edge (opening edge) 21 of the corrugated tube 20 at which a groove 22 located at the end of the corrugated tube is cut. The position of the corrugated tube 20 is regulated such that a portion of the front opening edge 21 of the corrugated tube 20 at which the electric wires W are exposed comes in partial contact with portions of the pair of stoppers 18 which are located at the outer sides of the notches 18a having an arc shape. That is, the front opening edge 21 side of the corrugated tube 20 is regulated not to enter the broadened width portions 12. The space between the pair of stoppers 18 which are alternately positioned is an electric wire accommodation space 19 where the electric wires W are accommodated. That is, the electric wire accommodation space 19 is diagonally provided in a plan view of the stoppers 18 in the radial direction of the electric wires W.

As illustrated in FIG. 3, the corrugated tube 20 has a substantially cylindrical (tubular) shape which is elastically recoilable in the insertion direction of the electric wires W. The corrugated tube 20 protects the electric wires W by covering the whole circumference of the electric wires W guided from the electric wire insertion portions 13 of the halved covers 11 and bundled together. That is, the corrugated tube 20 is formed in a bellows shape in which grooves 22 which are groove-like depressions are annularly provided on the outer periphery at intervals in the front-rear direction, and the corrugated tube 20 is locked in the insertion direction of the electric wires W by fitting the retaining protrusions 17 provided in the electric wire insertion portions 13 into the grooves 22.

According to the electric wire cover 10 in the embodiment, when the halved covers 11 are coupled to each other, the electric wire drawing portion 5 of the housing 2 is fitted into the locking recesses 16 of the lower halved cover 11, and the electric wires W drawn rearward from the electric wire drawing portion 5 are inserted into the corrugated tube 20. Then, the grooves 22 of the corrugated tube 20 are fitted with the retaining protrusions 17 of the lower halved cover 11 at the position where the front opening edge 21 of the corrugated tube 20 is located at the outer side of the stoppers 18 of the electric wire insertion portions 13 (rearward position than the stoppers 18), and the upper halved cover 11 is coupled to the lower halved cover 11. Then, the engagement pieces 14 and the engagement protrusions 15 of the broadened width portions 12 and the electric wire insertion portions 13 are locked to each other to keep the state where the halved covers 11 are coupled to each other.

FIG. 5B illustrates a comparative example. In the comparative example, the respective stoppers 18′ protrude to have, excluding the portions of the semi-arc-shaped notches 18a, a rectangular plate shape such that the stoppers 18′ separate the area at both inner side surfaces of the electric wire insertion portions 13. Thus, in the comparative example, the electric wires W are bitten between the stoppers 18′ when the halved covers 11 are coupled to each other. In contrast, in the electric wire cover 10 according to the embodiment, as illustrated in FIG. 5A, the stoppers 18 each having a quarter piece shape are provided on and alternately protrude at the portions of both inner side surfaces of the electric wire insertion portions 13 of the halved covers 11. Thus, the electric wires W are not bitten between the stoppers 18. That is, the electric wires W are movable into the electric wire accommodation space 19 along the arc-shaped notches 18a of the stoppers 18 when the halved covers 11 are coupled to each other, and it is therefore possible to easily and surely prevent the electric wires W from being bitten between the stoppers 18. Since the electric wires W are not bitten between the stoppers 18, it is also possible to surely prevent damage to the electric wires W and the like when the halved covers 11 are coupled to each other.

According to the embodiment above, the coupled state of the halved covers 11 is retained by the engagement pieces 14 and the engagement protrusions 15 provided in both the halved covers 11. However, the present invention is not limited to this. For example, a hinge(s) may be provided at one side of the halved covers 11 so that the halved covers are openable and closable via the hinge(s), and the engagement pieces 14 and the engagement protrusions 15 may be provided only at the other side of the halved covers 11 so that the coupled state of the halved covers 11 can be retained.

According to the embodiment above, a corrugated tube is used as an electric wire protector which protects the electric wires W inserted therein. However, the present invention is not limited to this. Tubes other than a corrugated tube may be used as the electric wire protector.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electric wire cover comprising:
halved covers in a pair mounted to a connector having at least one electric wire drawn rearward, the respective halved covers having electric wire insertion portions through which the drawn electric wire is inserted; and
an electric wire protector elastically recoilable in an insertion direction of the electric wire and retained in the electric wire insertion portions of the halved covers,
wherein the respective halved covers include regulators in the electric wire insertion portions, the regulators configured to come in partial contact with an opening edge of the electric wire protector at which the electric wire is exposed, and regulate a position of the electric wire protector.

2. The electric wire cover according to claim 1, wherein
the respective halved covers include broadened width portions having a box-shape and mounted to an electric wire drawing portion of the connector from which the electric wire is drawn,
the electric wire insertion portions have a rectangle tubular shape and extend rearward continuously from the broadened width portions, and
the regulators alternately protrude at positions of the respective electric wire insertion portions near the respective broadened width portions.

3. The electric wire cover according to claim 1, wherein
the at least one electric wire includes a plurality of electric wires,
the electric wire protector is a corrugated tube having a tubular shape and configured to protect the plurality of electric wires by covering a whole circumference of the plurality of electric wires guided from the electric wire insertion portions of the halved covers and bundled together, and
the corrugated tube is locked in the insertion direction by retaining protrusions provided in the electric wire insertion portions.

4. The electric wire cover according to claim 2, wherein the halved covers are halved parts having a same shape.
